(19) United States
(12) Patent Application Publication
(10) Pub. No.: US 2025/0337496 A1
(43) Pub. Date: Oct. 30, 2025

(54) END FACE COUPLER AND PREPARATION METHOD THEREOF

(71) Applicants: SILITH TECHNOLOGY (SUZHOU) CO., LTD., Shanghai (CN); SILITH TECHNOLOGY (SHANGHAI) CO., LTD., Shanghai (CN)

(72) Inventors: Zhexuan ZHENG, Shanghai (CN); Guangzhu ZHOU, Shanghai (CN); Nanfei ZHU, Shanghai (CN); Ke ZHANG, Shanghai (CN)

(73) Assignees: SILITH TECHNOLOGY (SUZHOU) CO., LTD., Shanghai (CN); SILITH TECHNOLOGY (SHANGHAI) CO., LTD., Shanghai (CN)

(21) Appl. No.: 19/023,433

(22) Filed: Jan. 16, 2025

(30) Foreign Application Priority Data
Apr. 30, 2024 (CN) 202410532754.5

(51) Int. Cl. H04B 10/40

(52) U.S. Cl. CPC H04B 10/40

(57) ABSTRACT

Present application relates to field of optical communication, coupler is configured to couple laser emitting unit and laser receiving unit, coupler is arranged between laser emitting unit and laser receiving unit and is attached to receiving end-face of laser receiving unit, and coupler includes substrate; MIM waveguide structures are arranged on M layers of substrate and are composed of grating antennas formed by single-layer MIM waveguide structures, and M is positive integer; thin film deposition layer is arranged on one side of M layers of MIM waveguide structures; laser emitting unit is used for emitting laser. Beneficial effects lie in that laser emission unit, through M-layer MIM waveguide structure, is convenient to integrate and reduces occupied space compared with existing convex lens structure.

### CROSS-REFERENCE TO RELATED APPLICATION

This application claims the priority benefit of China application serial no. 202410532754.5, filed on Apr. 30, 2024. The entirety of the above-mentioned patent application is hereby incorporated by reference herein and made a part of this specification.

### TECHNICAL FIELD

The present application relates to the technical field of optical communications, and in particular to an end-face coupler and a preparation method thereof.

### BACKGROUND

A silicon optoelectronic technology includes a plurality of artificial light, electrical, optoelectronic components on a same chip, which may provide a low-cost, low-power, high-speed optical solution for a data communication, a telephone communication, particularly an optical communication. By integrating the optical, electrical, optoelectronic components on a same substrate, it is able to obtain an adjustment to a transceiver channel and transmission speed. An optical transceiver module is a core unit in an optical network. An optical transceiver module having miniaturization, low energy consumption, multi-channel, and low-cost is becoming a development trend. As a core device of the optical transceiver module, a light emitting assembly and a light receiving assembly must also be developed towards a plurality of characteristics including miniaturization and multi-channel.

In the prior art, when coupling a laser light sent by a laser emitting unit with a laser receiving unit, a convex lens is configured to focus the laser light. However, if the convex lens is relatively large, when in use, if a plurality of laser emitting units are arranged in an array for use, then a plurality of convex lenses will be required to be arranged in an array for use, and at a same time, the plurality of laser emitting units will be arranged relatively far away, causing an integration level insufficient, and occupying more space.

### SUMMARY

The purpose of the present application is providing an end-face coupler and a preparation method thereof, by integrating a coupler on a laser receiving unit, thereby facilitating integration and reducing a space occupied.

The present application provides an end-face coupler, configured to couple a laser emitting unit and a laser receiving unit, wherein the coupler is arranged between the laser emitting unit and the laser receiving unit, and attaching to a receiving end-face of the laser receiving unit, comprising: a substrate; an M-layer MIM waveguide structure arranged on the substrate, the M-layer MIM waveguide structure comprises a grating antenna composed of a single-layer MIM waveguide structure, and M is a positive integer; a thin film deposition layer arranged on one side of the M-layer MIM waveguide structure; the laser emitting unit is configured to emit laser light; the M-layer MIM waveguide structure is configured to receive a light spot emitted by the laser emitting unit and layer the light spot being received into N layers of light waves, the M-layer MIM waveguide structure sequentially converges and couples the N layers of light waves into one layer light wave according to the layers, N is a positive integer, and N is less than or equal to M; the laser receiving unit is configured to receive the one layer light wave after having been coupled.

Preferably, the MIM waveguide structure comprises a plurality of metal layers and a plurality of insulation layers.

Preferably, the MIM waveguide structure has a periodic material arranged, the periodic material is composed of a material having the plurality of metal layers and the plurality of insulation layers arranged alternately, so that the light waves in the MIM waveguide structure are disturbed.

Preferably, by setting at least one of thickness, material, arrangement manner and refractive index of the periodic material, a specific direction of the light wave is adjusted to a free space after passing through the single-layer MIM waveguide structure, so as to realize a directional radiation of the light wave.

Preferably, there is a plasma gap arranged between each of the plurality of metal layers and each of the plurality of insulation layers, and through the plasma gap, a light guiding mode of an optical wave transmission is realized.

Preferably, N layers of the light waves have both energies and wave phases equal after having passed through the MIM waveguide structure.

Preferably, the laser receiving unit comprises a receiving window, and the receiving window is larger than the light spot emitted by the laser emitting unit.

Preferably, the metal layer is made of metal silver.

Preferably, the insulation layer is made of silicon dioxide.

The present application further provides a manufacturing method for the end-face coupler, configured to prepare the end-face coupler, wherein comprising:
S1, providing a substrate;
S2, forming a first insulation layer on a surface layer of the substrate by vapor deposition technology;
S3, etching the first insulation layer to remove a part of material of the first insulation layer;
S4, forming a first metal layer on a surface layer of the first insulation layer by the vapor deposition technology;
S5, performing chemical corrosion and mechanical grinding on a surface of the first metal layer, followed by polishing the surface of the first metal layer;
S6, forming a second insulation layer on the first metal layer by the vapor deposition technology;
S7, forming a second metal layer on a surface layer of the second insulation layer by the vapor deposition technology;
S8, etching the second metal layer, to remove a part of material of the second metal layer;
S9, repeating S2-S8 for M-1 times, to form an M-layer MIM waveguide structure;
S10, depositing a silicon nitride film on a topmost layer by physical vapor deposition.

The beneficial effects of the present application are: by arranging the M-layer MIM waveguide structure in the laser emitting unit, a plurality of light waves are separated into the M-layer MIM waveguide structure, after being reflected for a plurality of periods by a periodic material, a direction of the emitted light waves can be adjusted according to a grating design, including changing the refractive index, so that in a case of satisfying both the energies and the wave phases equal, the plurality of light waves will be in a same line, that is, a layer of the light waves, thus it achieves converging and coupling the plurality of light waves, before being received by a silicon optical chip, and being concentrated to the laser receiving unit by the M-layer MIM waveguide structure. Compared with an existing convex lens structure, the present application facilitates integration, and reduces an occupied space.

### BRIEF DESCRIPTION OF THE DRAWINGS

FIG. 1 illustrates a schematic structural diagram on an M-layer MIM waveguide perpendicular to a light wave incident angle according to the present application;

FIG. 2 illustrates a schematic diagram on a coupling structure between the laser emitting unit and the laser receiving unit according to the present application;

FIG. 3 illustrates a schematic structural diagram on the prior art in the background of the present application;

FIG. 4 illustrates a schematic structural diagram on a side of the laser emitting unit according to the present application;

FIG. 5 illustrates a schematic structural diagram on a side of the laser receiving unit according to the present application;

FIG. 6 illustrates a schematic structural diagram on a receiving window according to the present application;

FIG. 7 illustrates a schematic structural diagram at a viewing angle on a multi-layer light wave passing through the M-layer MIM waveguide structure according to the present application;

FIG. 8 illustrates a schematic structural diagram at another viewing angle on a multi-layer light wave passing through the M-layer MIM waveguide structure according to the present application;

FIG. 9 illustrates a flowchart on a preparation method of the present application;

FIG. 10 illustrates a schematic structural diagram on a substrate according to the present application;

FIG. 11 illustrates a schematic structural diagram on an insulation layer formed on the substrate according to the preparation method of the present application;

FIG. 12 illustrates a schematic structural diagram on an insulation layer after a part of material having been removed according to the preparation method of the present application;

FIG. 13 illustrates a schematic structural diagram on a metal layer being formed on the insulation layer according to the preparation method of the present application;

FIG. 14 illustrates a schematic structural diagram of performing a polishing process on the metal layer according to the preparation method of the present application;

FIG. 15 illustrates a schematic structural diagram of forming an insulation layer on a metal layer according to the preparation method of the present application;

FIG. 16 illustrates a schematic structural diagram of forming a metal layer on an insulation layer according to the preparation method of the present application;

FIG. 17 illustrates a schematic structural diagram on a metal layer after a part material having been removed on a surface according to the preparation method of the present application;

FIG. 18 illustrates a schematic structural diagram on an optical wave entering a laser receiving unit through an MIM waveguide structure according to the present application;

FIG. 19 illustrates a schematic structural diagram on an X-Y plane in FIG. 18 of the present application;

FIG. 20 illustrates a schematic structural diagram on an Y-Z plane in FIG. 18 of the present application;

FIG. 21 illustrates a schematic simulation diagram of the present application.

### DETAILED DESCRIPTION OF DISCLOSURED EMBODIMENTS

In order to make the purpose, technical solution and advantages of the present application clearer and more explicit, further detailed descriptions of the present application are stated here, referencing to the attached drawings and some embodiments of the present application. Obviously, the described embodiments are part of, but not all of, the embodiments of the present application. Based on the embodiments of the present application, all other embodiments obtained by those of ordinary skills in the art without any creative work are included in the scope of protection of the present application. Unless otherwise defined, technical or scientific terms used herein should have the meanings usually understood by those of ordinary skills in the art to which the present application belongs. As used herein, the terms “comprise” and the like are intended to mean that an element or item appearing before the term encompasses elements or items appearing after the term and the equivalents thereof, instead of excluding other elements or items.

In the prior art, when coupling a laser light transmitted from a laser emitting unit with a laser receiving unit, a convex lens is configured for focusing, and in conjunction with FIG. 3, when the convex lens is large, during working, if a plurality of laser emitting units are arranged in an array for use, it requires a plurality of convex lenses also to be arranged in an array for use, while at a same time, the laser emitting units are placed relatively farther, thus having an insufficient integration level, and occupying more space. The purpose of the present application is integrating a coupler into the laser receiving unit, thereby facilitating to integrate and reducing the space being occupied.

A structure of a Metal-Insulator-Metal (MIM) waveguide mentioned in the present application is a special surface plasma nanostructure, having a wide application prospect in a plurality of fields including surface plasmon photonics, nano photonics and more. The MIM waveguide is composed by two layers of metal and an insulator dielectric layer therebetween, and transmitting optical wave energy through a plurality of surface plasmon polaritons (SPPs) on an interface between the metal and the insulator dielectric. A principle of a waveguide structure realizing light wave directional transmission mainly depends on a special structural design and an interaction between the metal and the insulator. The MIM waveguide structure is composed of an insulator layer between two metal plates, when the light wave enters such a structure, the light wave will be transmitted through the insulator layer between the two metal plates. Such a design of the structure enables the light waves to be reflected multiple times between the two metal plates, thereby achieving the light wave directional transmission. Such a structure can effectively reduce loss generated in a nano focusing process, having a simple structure and being convenient to manufacture.

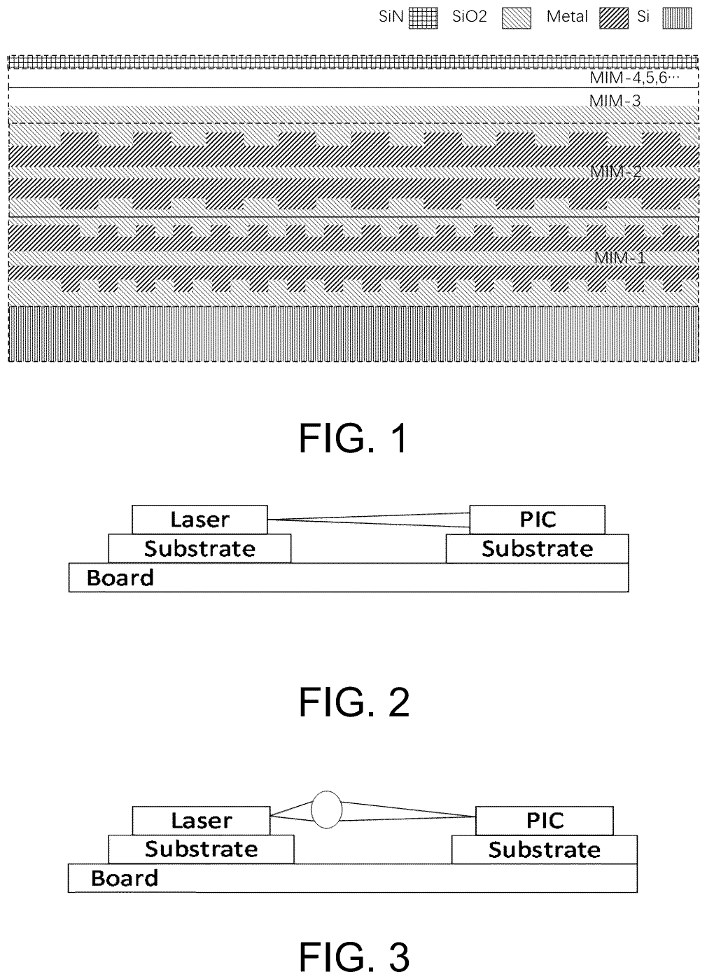

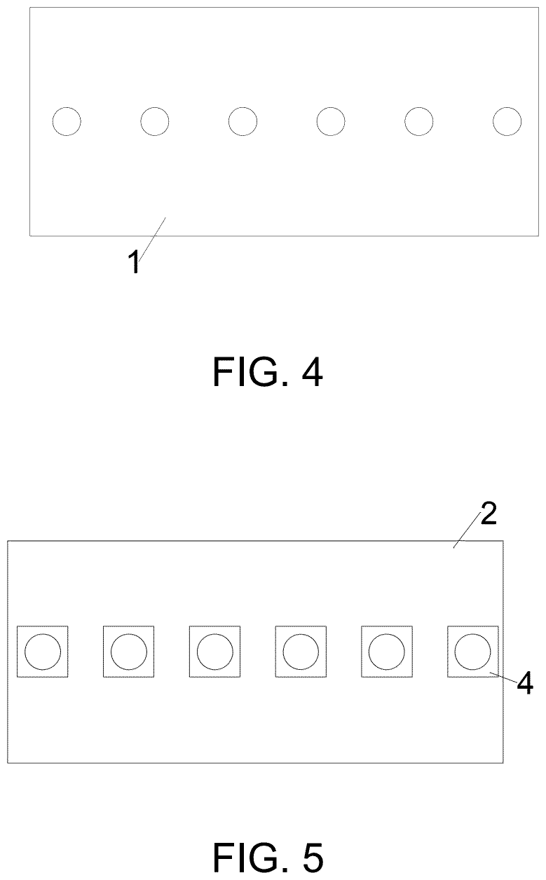

Referencing to FIG. 1, FIG. 2 and FIG. 4, an end-face coupler, configured to couple a laser emitting unit 1 and a laser receiving unit 2. The coupler is arranged between the laser emitting unit 1 and the laser receiving unit 2, and attaching to a receiving end-face of the laser receiving unit 2, comprising: a substrate; an M-layer MIM waveguide structure 3 arranged on the substrate, the M-layer MIM waveguide structure 3 comprises a grating antenna composed of a single-layer MIM waveguide structure, and M is a positive integer; a thin film deposition layer arranged on one side of the M-layer MIM waveguide structure 3; the laser emitting unit 1 is configured to emit laser light; the M-layer MIM waveguide structure 3 is configured to receive a light spot emitted by the laser emitting unit 1 and layer the light spot being received into N layers of light waves, the M-layer MIM waveguide structure 3 sequentially converges and couples the N layers of light waves into one layer light wave according to the layers, N is a positive integer, and N is less than or equal to M; so that an MIM waveguide structure is always dividing a plurality of light waves of different sizes completely; while the laser receiving unit 2 is configured to receive the one layer light wave after having been received and coupled.

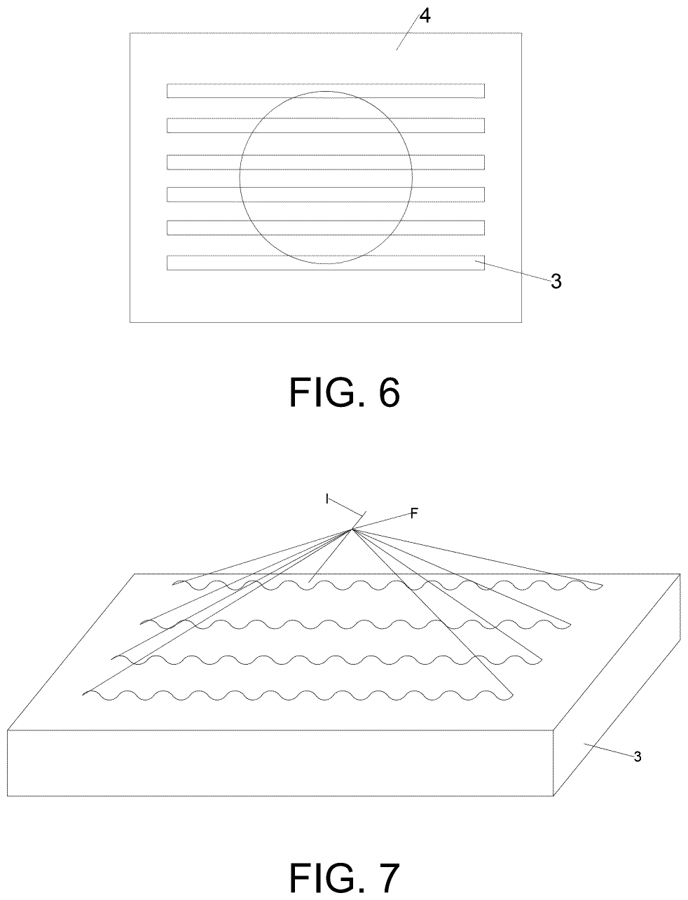

Specifically, the laser emitting unit 1 emits the laser light and the laser receiving unit 2 receives the laser light, the end-face coupler is arranged on the receiving end-face of the laser receiving unit 2. In combination with FIG. 6, the end-face coupler is composed of M layers of MIM waveguide structures, and the M-layer MIM waveguide structure 3 is composed of a grating antenna formed by a single-layer MIM waveguide structure, and when the laser light emitted by the laser emitting unit 1 falls on the M-layer MIM waveguide structure 3, the laser light is divided into N lines of optical waves. By using the MIM waveguide structure, it realizes a light guide mode based on a plasma gap and a disturbance of a periodic material to the light waves in a waveguide.

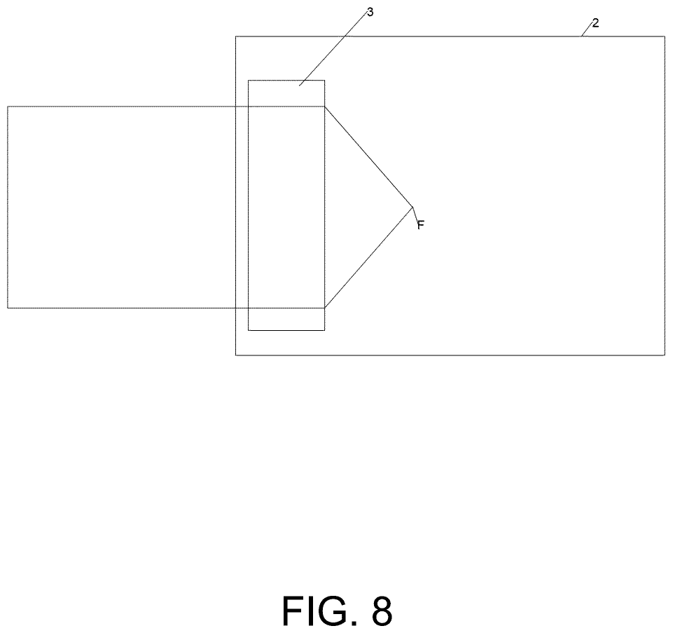

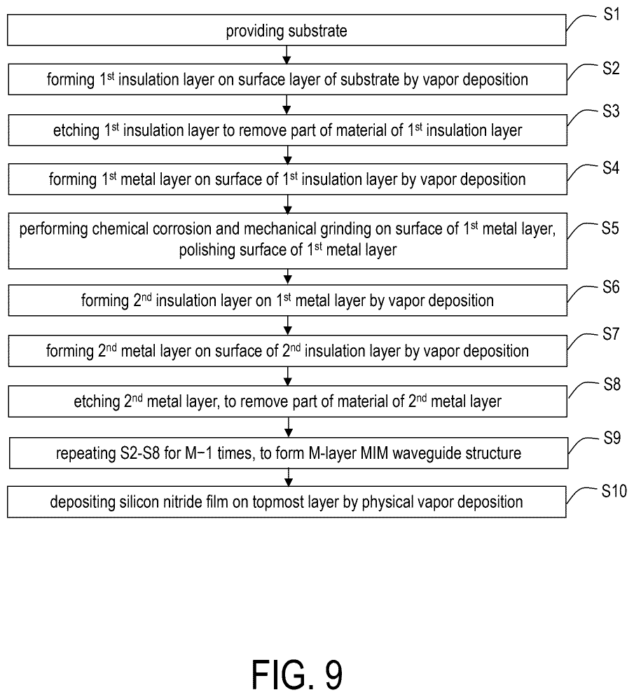

Shown as FIG. 7 and FIG. 8, M layers of light waves passing through the M-layer MIM waveguide structure 3 are sequentially converged on a straight line at an F position, that is, a straight line I, and coupled to form a light wave, and the light wave comprises multiple layers of light waves having passed through different MIM waveguide structures, then the light wave is received by the laser receiving unit 2. Thus on one hand, an efficiency of the optical wave transmission is improved, and on another hand, integration is facilitated. In addition, the M-layer MIM waveguide structure 3 generates a specific modulation on a waveguide amplitude by using an amplitude holographic method, so that a free space focusing field is reconstructed, and an action of focusing a guide mode field emitted from the laser emitting unit 1 to the laser receiving unit 2 is further achieved.

In a plurality of embodiments, the laser emitting unit 1 may be a laser, and the laser receiving unit 2 may be a silicon optical chip.

In a plurality of embodiments, the MIM waveguide structure comprises a plurality of metal layers and a plurality of insulation layers.

In a plurality of embodiments, the MIM waveguide structure has a periodic material arranged, the periodic material is composed of a material having the plurality of metal layers and the plurality of insulation layers arranged alternately, so that the light waves in the MIM waveguide structure are disturbed.

Specifically, the light waves are guided and controlled by using an alternating layer composed of the metal and the insulator.

In a plurality of embodiments, by setting at least one of thickness, material, arrangement manner and refractive index of the periodic material, a specific direction of the light wave is adjusted to a free space after passing through the single-layer MIM waveguide structure, so as to realize a directional radiation of the light wave.

Specifically, the thickness of the metal layer and the insulation layer in the periodic material is a key factor affecting the light wave propagation, and by adjusting the thickness of the layers, it is possible to change the phase delay and the reflection condition of the light wave in the waveguide structure, thereby controlling an angle and a direction of the light wave when emitting from the waveguide. A proper design of the thickness can make the light wave generate a Bragg reflection or diffraction at a specific angle, so as to realize a directional radiation.

There is a significant influence on a propagation characteristic of the light wave, by selecting a material of the metal layer and the insulation layer. Since different metal materials and different insulating materials have different optical properties including refractive index, absorptivity and reflectivity, thus by selecting a material, it is possible to optimize the propagation efficiency of the light wave in the waveguide structure, and control the direction of the light wave emitted from the waveguide.

The arrangement manner of the periodic material, that is, a sequence of the plurality of metal layers and the plurality of insulating layers and a geometric shape of the periodic structure, are also an important means for adjusting the directional radiation of the light wave. Thus by designing a plurality of different arrangement modes, including changing a period length, introducing a defect or a gradient structure, and more, it is possible to achieve regulating a light wave propagation mode, thereby controlling the radiation direction of the light wave.

The refractive index is one of the factors for determining the light wave propagation direction, and by adjusting the refractive index of the metal layer and the insulation layer, it is possible to change the propagation speed and a path of the light wave in the waveguide structure, thereby affecting the radiation direction of the light wave, which can be achieved by selecting a suitable material, changing a doping concentration of the material, or using an external field (including an electric field and a magnetic field).

Further, by setting the thickness, the material, the arrangement mode and the refractive index of each layer of the MIM waveguide structure, the specific direction of the light waves to the free space is adjusted, after passing through the single-layer MIM waveguide structure, so as to achieve the directional radiation of the light waves, and converge the multilayer light waves.

In a plurality of specific embodiments, there is a plasma gap arranged between each of the plurality of metal layers and each of the plurality of insulation layers, and through the plasma gap, a light guiding mode of an optical wave transmission is realized.

Specifically, in the MIM waveguide structure, when a plasma gap is arranged between each of the plurality of metal layers and each of the plurality of insulating layers, such a gap may significantly affect a conduction mode of the light wave in the structure, a plurality of free electrons in the plasma gap may interact with the light wave, thereby changing a propagation characteristic of the light wave and achieving a specific light guiding mode. In addition, by adjusting a size and a shape of the gap and a density and property of the plasma therein, it is possible to control both propagation path and propagation mode of the light wave in the waveguide accurately.

In a plurality of specific embodiments, the N layers of light waves have both energies and wave phases equal, after having passed through the MIM waveguide structure.

Specifically, it is an important design index of achieving an efficient transmission of the energies of the light waves and achieving the wave phases equal. The wave phases are equal means that the light waves of different layers have a same phase delay in the propagation process, which helps to maintain a coherence of the light wave and improve the energy transmission efficiency.

In a plurality of specific embodiments, the laser receiving unit 2 comprises a receiving window 4, and the receiving window 4 is larger than the light spot emitted by the laser emitting unit 1.

Specifically, shown as FIG. 5 and FIG. 6 together, a plurality of circles are shown as a plurality of light spots having been received, and by arranging the receiving window 4 larger than the light spots emitted by the laser emitting unit 1, it facilitates to receive the light waves completely, so as to avoid the loss of an optical data.

In a plurality of specific embodiments, the metal layer is metal silver.

Specifically, the metal silver is adopted, since the metal silver has a plurality of advantages including a high reflectivity, a low absorptivity and more.

In a plurality of specific embodiments, the metal layer is metal aluminum.

In a plurality of specific embodiments, the insulating layer is silicon dioxide.

Firstly, the silicon dioxide is an optically transparent material having a relatively lower absorption and scattering loss in a spectral range of visible light and near-infrared light;

Secondly, the silicon dioxide has a stable chemical and physical property, being able to keep an optical property thereof under various environmental conditions.

Finally, a preparation process of the silicon dioxide is mature

In a plurality of specific embodiments, the insulating layer may be made of silicon nitride.

In a plurality of specific embodiments, the thin film deposition layer is made of silicon nitride.

Specifically, first, the silicon nitride has excellent optical performance, which shows relatively low absorption and scattering loss in the spectral range of visible light and near-infrared light, so that the light waves can be efficiently propagated in a silicon nitride film, reducing an energy loss.

Secondly, the silicon nitride has an excellent chemical stability and thermal stability.

Finally, the silicon nitride further has an appropriate refractive index.

In a plurality of specific embodiments, the substrate is a monocrystalline silicon material.

A monocrystalline silicon acting as a substrate material, has a great importance in integrated circuit industry, main advantages thereof include:
firstly, the monocrystalline silicon is made of a high-purity silicon material, and the high-purity ensures that an impurity content in the chip is very low, thereby avoiding an adverse reaction in a chip manufacturing process, thereby ensuring quality of a chip.

Secondly, a thermal expansion coefficient of a monocrystalline silicon wafer is very small, which means that during a manufacturing process of the chip, the monocrystalline silicon wafer will not have a great deformation due to a temperature change.

Finally, a physical morphological structure of the monocrystalline silicon is stable, that is an important reason for choosing the monocrystalline silicon as the substrate.

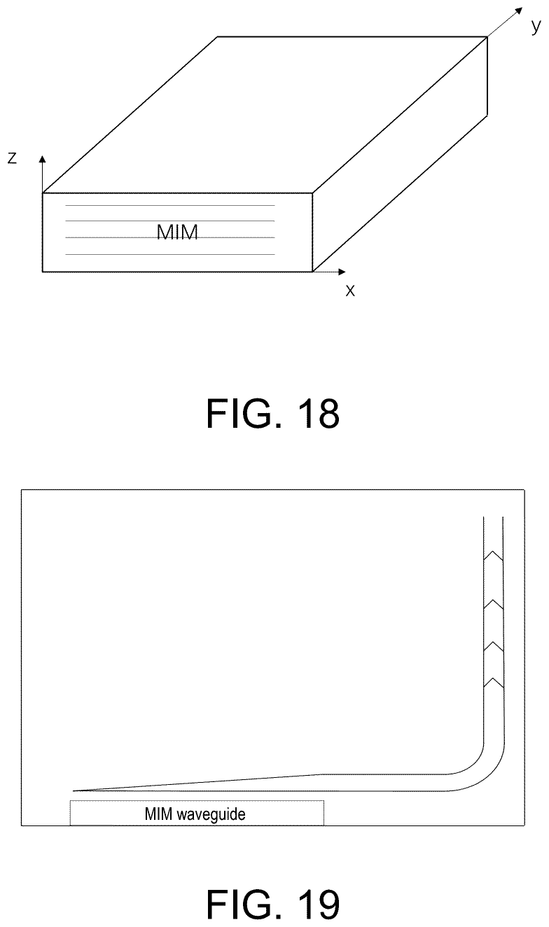

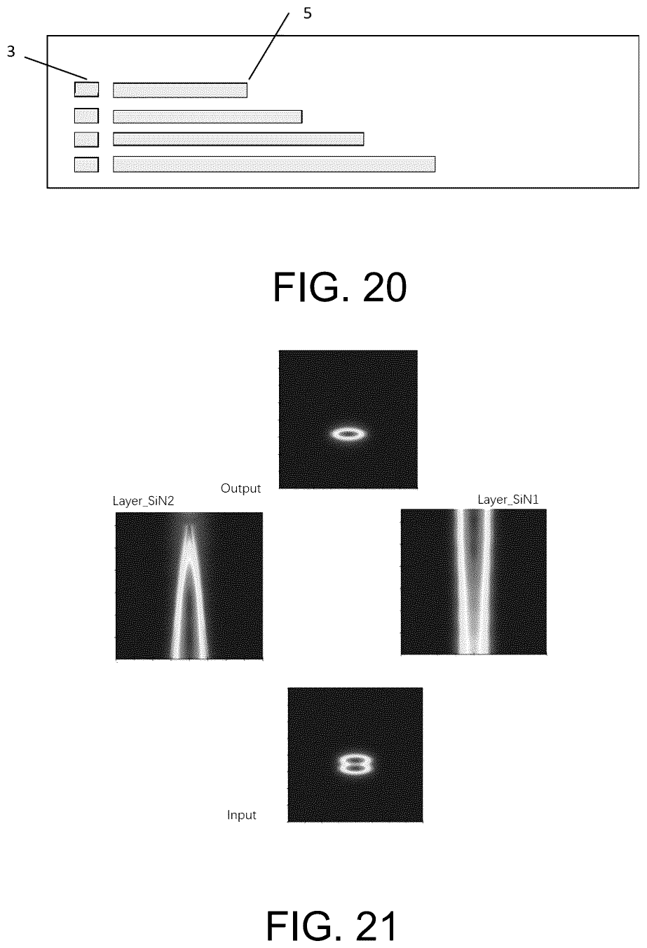

In a plurality of specific embodiments, with reference to FIG. 18, FIG. 19, and FIG. 20, the laser receiving unit 2 has a multi-layer SiN waveguide 5 arranged inside, the light wave passes through the M-layer MIM waveguide structure 3 before passing through the multi-layer SiN waveguide 5, so as to facilitate the receiving of the silicon optical chip. Based on the Evanescent Wave Coupling principle, the light wave in the M-layer MIM waveguide structure 3 is coupled in the multi-layer SiN waveguide 5, and a direction of the light wave is also changed, so that different layers of light waves that have been converged into one layer of light waves through the MIM waveguide structure further converge to only one layer.

In a plurality of specific embodiments, with reference to FIG. 21, Layer_SiN2 is a schematic diagram on an upper-layer SiN waveguide light on the X-Y plane structure in FIG. 18, LAYER_SIN 1 is a schematic diagram on a lower-layer SiN waveguide light on the X-Y plane structure in FIG. 18, Input is an optical wave incident to the multi-layer SiN waveguide 5 after passing through the M-layer MIM waveguide structure 3, and Output is an optical wave converged into a layer after passing through the multi-layer SiN waveguide 5.

The present application further provides a manufacturing method for the end-face coupler, configured to prepare the end-face coupler, comprising:
S1, providing a substrate;
S2, forming a first insulation layer on a surface layer of the substrate by vapor deposition technology;
S3, etching the first insulation layer to remove a part of material of the first insulation layer;
S4, forming a first metal layer on a surface layer of the first insulation layer by the vapor deposition technology;
S5, performing chemical corrosion and mechanical grinding on a surface of the first metal layer, followed by polishing the surface of the first metal layer;
S6, forming a second insulation layer on the first metal layer by the vapor deposition technology;
S7, forming a second metal layer on a surface layer of the second insulation layer by the vapor deposition technology;
S8, etching the second metal layer, to remove a part of material of the second metal layer;
S9, repeating S2-S8 for M-1 times, to form an M-layer MIM waveguide structure 3;
S10, depositing a silicon nitride (SiN) film on a topmost layer by physical vapor deposition.

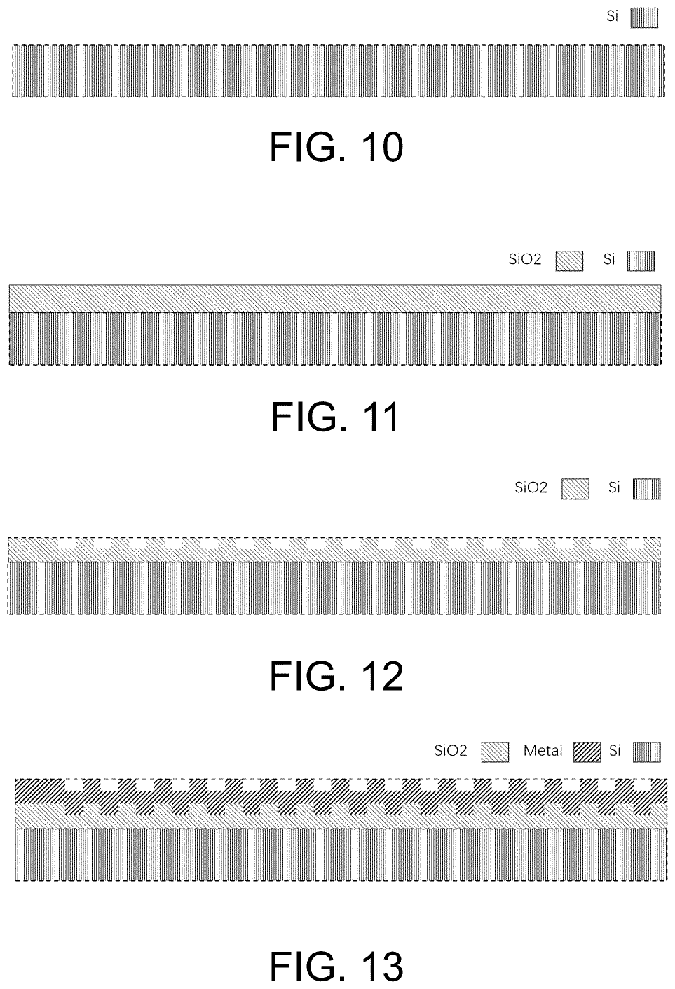

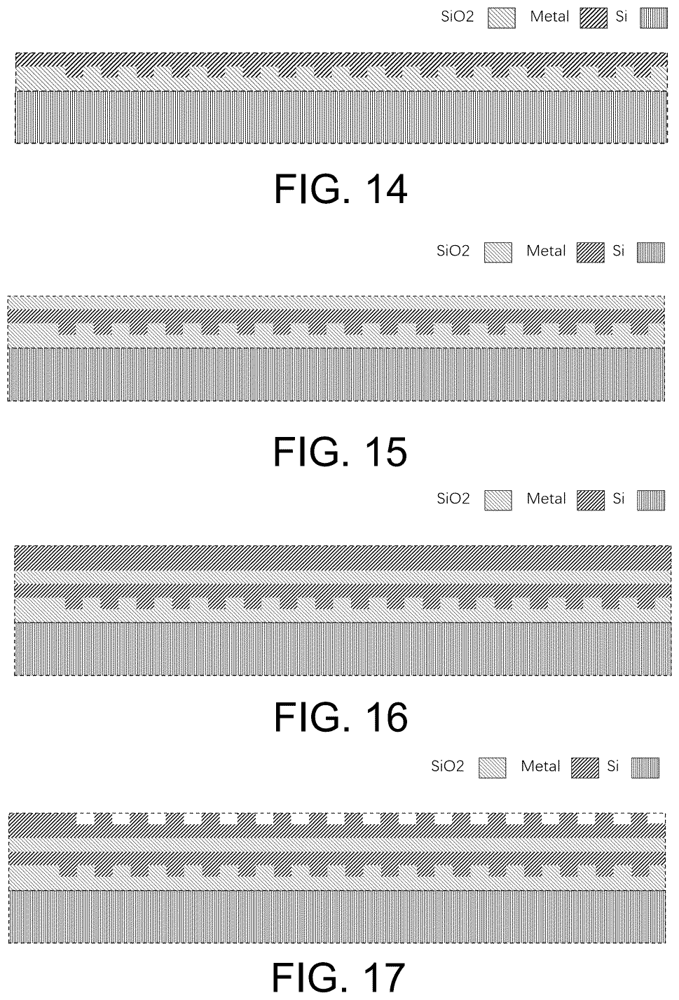

Specifically, S1, providing the substrate, shown as FIG. 10, the substrate may be monocrystalline silicon.
S2, shown as FIG. 11, forming a first insulation layer on a surface layer of the substrate by vapor deposition technology, the first insulation layer may be SiO₂;
S3, shown as FIG. 12, etching the first insulation layer to remove a part of material of the first insulation layer;
S4, shown as FIG. 13, forming a first metal layer on a surface layer of the first insulation layer by the vapor deposition technology;
S5, shown as FIG. 14, performing chemical corrosion and mechanical grinding on a surface of the first metal layer, followed by polishing the surface of the first metal layer;
S6, shown as FIG. 15, forming a second insulation layer on the first metal layer by the vapor deposition technology;
S7, shown as FIG. 16, forming a second metal layer on a surface layer of the second insulation layer by the vapor deposition technology;
S8, shown as FIG. 17, etching the second metal layer, to remove a part of material of the second metal layer;
S9, shown as FIG. 1, repeating S2-S8 for M-1 times, to form the M-layer MIM waveguide structure 3;
S10, shown as FIG. 1, depositing a silicon nitride (SiN) film on a topmost layer by physical vapor deposition.

Through the description of the foregoing implementations, a person skilled in the art may clearly understand that, for the purpose of convenient and brief description, the division of the foregoing functional modules is used only for illustration, and in actual application, the function allocation may be completed by different functional modules according to needs, that is, the internal structure of the apparatus is divided into different functional modules to complete all or some of the functions described above. For a specific working process of the foregoing system, apparatus, and unit, reference may be made to a corresponding process in the foregoing method embodiments, and details are not described herein again.

While the embodiments of the present application have been described in detail above, it will be apparent to those skilled in the art that various modifications and variations can be made to the embodiments. It should be understood, however, that such modifications and variations are within the scope and spirit of the present application as set forth in the claims. Moreover, the present application described herein is capable of other embodiments and of being practiced or of being carried out in various ways.

What is claimed is:

1. An end-face coupler, configured to couple a laser emitting unit and a laser receiving unit, wherein the coupler is arranged between the laser emitting unit and the laser receiving unit, and attaching to a receiving end-face of the laser receiving unit, comprising:
a substrate;
an M-layer MIM waveguide structure arranged on the substrate, the M-layer MIM waveguide structure comprises a grating antenna composed of a single-layer MIM waveguide structure, and M is a positive integer;
a thin film deposition layer arranged on one side of the M-layer MIM waveguide structure;
the laser emitting unit is configured to emit laser light;
the M-layer MIM waveguide structure is configured to receive a light spot emitted by the laser emitting unit and layer the light spot being received into N layers of light waves, the M-layer MIM waveguide structure sequentially converges and couples the N layers of light waves into one layer light wave according to the layers, N is a positive integer, and N is less than or equal to M;
the laser receiving unit is configured to receive the one layer light wave after having been coupled;
the MIM waveguide structure has a periodic material arranged, the periodic material is composed of a material having a plurality of metal layers and a plurality of insulation layers arranged alternately, so that the light waves in the MIM waveguide structure are disturbed.

2. The end-face coupler according to claim 1, wherein by setting at least one of thickness, material, arrangement manner and refractive index of the periodic material, a specific direction of the light wave is adjusted to a free space after passing through the single-layer MIM waveguide structure, so as to realize a directional radiation of the light wave.

3. The end-face coupler according to claim 1, wherein each of the plurality of metal layers and each of the plurality of insulation layers have a plasma gap arranged in between, and through the plasma gap, a light guiding mode of an optical wave transmission is realized.

4. The end-face coupler according to claim 1, wherein N layers of the light waves have both energies and wave phases equal, after having passed through the MIM waveguide structure.

5. The end-face coupler according to claim 1, wherein the laser receiving unit comprises a receiving window, and the receiving window is larger than the light spot emitted by the laser emitting unit.

6. The end-face coupler according to claim 1, wherein the substrate is a monocrystalline silicon material.

7. The end-face coupler according to claim 1, wherein the metal layer is made of metal silver or metal aluminum.

8. The end-face coupler according to claim 1, wherein the insulation layer is made of silicon dioxide or silicon nitride.

9. The end-face coupler according to claim 1, wherein the thin film deposition layer is made of silicon nitride.

10. A manufacturing method for the end-face coupler, configured to prepare the end-face coupler according to claim 1, wherein comprising:
S1, providing a substrate;
S2, forming a first insulation layer on a surface layer of the substrate by vapor deposition technology;
S3, etching the first insulation layer to remove a part of material of the first insulation layer;
S4, forming a first metal layer on a surface layer of the first insulation layer by the vapor deposition technology;
S5, performing chemical corrosion and mechanical grinding on a surface of the first metal layer, followed by polishing the surface of the first metal layer;
S6, forming a second insulation layer on the first metal layer by the vapor deposition technology;
S7, forming a second metal layer on a surface layer of the second insulation layer by the vapor deposition technology;
S8, etching the second metal layer, to remove a part of material of the second metal layer;
S9, repeating S2-S8 for M-1 times, to form an M-layer MIM waveguide structure;
S10, depositing a silicon nitride film on a topmost layer by physical vapor deposition.

11. The manufacturing method according to claim 10, wherein by setting at least one of thickness, material, arrangement manner and refractive index of the periodic material, a specific direction of the light wave is adjusted to a free space after passing through the single-layer MIM waveguide structure, so as to realize a directional radiation of the light wave.

12. The manufacturing method according to claim 10, wherein each of the plurality of metal layers and each of the plurality of insulation layers have a plasma gap arranged in between, and through the plasma gap, a light guiding mode of an optical wave transmission is realized.

13. The manufacturing method according to claim 10, wherein N layers of the light waves have both energies and wave phases equal, after having passed through the MIM waveguide structure.

14. The manufacturing method according to claim 10, wherein the laser receiving unit comprises a receiving window, and the receiving window is larger than the light spot emitted by the laser emitting unit.

15. The manufacturing method according to claim 10, wherein the substrate is a monocrystalline silicon material.
